(19) United States
(12) Patent Application Publication
(10) Pub. No.: US 2026/0087223 A1
(43) Pub. Date: Mar. 26, 2026

(54) DESIGN FLOW OF INTEGRATED CIRCUIT (IC) WITH THERMAL SENSING RESISTOR

(71) Applicant: Taiwan Semiconductor Manufacturing Company, Ltd., Hsinchu (TW)

(72) Inventors: Szu-Lin LIU, Hsinchu (TW); Yung-Chow PENG, Hsinchu (TW); Chih-Lin CHEN, Hsinchu (TW); Chia-Chung CHEN, Hsinchu (TW); Chung-Sheng YUAN, Hsinchu (TW); Chung-Hsing WANG, Hsinchu (TW); Yi-Kan CHENG, Hsinchu (TW)

(73) Assignee: Taiwan Semiconductor Manufacturing Company, Ltd., Hsinchu (TW)

(21) Appl. No.: 19/006,661

(22) Filed: Dec. 31, 2024

Related U.S. Application Data
(60) Provisional application No. 63/698,187, filed on Sep. 24, 2024.

(51) Int. Cl. G06F 30/392; G06F 30/3953; G06F 30/396; G06F 119/08

(52) U.S. Cl. CPC G06F 30/392; G06F 30/3953; G06F 30/396; G06F 2119/08

(57) ABSTRACT

An embodiment method of forming a layout plan of an integrated circuit (IC) device includes obtaining a placement of a plurality of digital circuit cells in a region of a layout plan; obtaining an initial placement of one or more thermal sensing resistor cells in a subset of a plurality of metallization layers and a subset of a plurality of via layers of the layout plan; obtaining a routing plan based on a clock tree synthesis and the initial placement of the one or more thermal sensing resistor cells; performing a thermal analysis based on the placement of the plurality of digital circuit cells and the routing plan to identify one or more areas of interest in the region of the layout plan; and obtaining a refined placement of the one or more thermal sensing resistor cells respectively over the one or more areas of interest.

### PRIORITY CLAIM AND CROSS-REFERENCE

This patent application claims the benefit of U.S. Provisional Ser. No. 63/698,187 filed on Sep. 24, 2024, the entire disclosure of which is hereby incorporated by reference.

### BACKGROUND

The semiconductor industry has experienced rapid growth due to ongoing improvements in integration density of a variety of components (e.g., photoelectric devices, electrical components, or the like). In some applications, the miniaturized scale of semiconductor devices, also referred to as integrated circuit (IC) devices, results in greater demands on thermal management and heat dissipation efficiency due to high power density of the semiconductor device. In some cases, the thermal management of an IC device may rely on measuring the temperature at one or more areas of interest of the IC device that correspond to a circuit block likely being a heat source of the IC device, a circuit block susceptive to temperature changes, and/or a circuit block configurable based on a measured temperature thereof.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a block diagram of a semiconductor device, in accordance with some embodiments.

FIG. 1B is a simplified floor plan of a semiconductor device, in accordance with some embodiments.

FIG. 2 is a cross-sectional view of a semiconductor device, in accordance with some embodiments.

FIG. 3 is a circuit diagram of a temperature sensor, in accordance with some embodiments.

FIGS. 4A-4B are simplified floor plans of semiconductor devices, in accordance with some embodiments.

FIG. 5 is a cross-sectional view of a semiconductor device with a thermal sensing resistor formed in the metallization layers, in accordance with some embodiments.

FIGS. 6A-6E are layout diagrams of various thermal sensing resistor cell examples, in accordance with some embodiments.

FIG. 7 is a processing flow diagram of at least a portion of an integrated circuit (IC) design flow for a digital region of a semiconductor device, in accordance with some embodiments.

FIG. 8 is a flowchart of a method of forming a layout plan of an IC device, in accordance with some embodiments.

FIG. 9 is a block diagram of an electronic design automation (EDA) system in accordance with some embodiments.

FIG. 10 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of.” In this disclosure, the phrase “one of A, B, and C” means “A, B, and/or C” (A, B, C, A and B, A and C, B and C, or A, B and C), and does not mean one element from A, one element from B, and one element from C, unless otherwise described.

According to one or more embodiments of the present disclosure, a design flow for a thermal sensing resistor is incorporated into a design flow for a digital region of an integrated circuit (IC) device (i.e., a digital design flow). In some embodiments, a digital region of an IC device corresponds to a region including digital circuit blocks. In some embodiments, compared to an analog region of the IC device including analog circuit blocks or mixed mode circuit blocks, the components in the digital region are to be made with a higher density, smaller operating voltage, smaller dynamic voltage, and faster operating speed.

In some embodiments, a digital design flow incorporating a design flow for a thermal sensing resistor according to one or more embodiments of this disclosure includes obtaining a placement of a plurality of digital circuit cells in the digital region, obtaining an initial placement of a thermal sensing resistor cell (indicative of the thermal sensing resistor) in a subset of a plurality of metallization layers of the layout plan and a subset of a plurality of via layers of the layout plan over the digital region, obtaining a routing plan based on a clock tree synthesis and the initial placement of the one or more thermal sensing resistor cells, performing a thermal analysis based on the placement of the plurality of digital circuit cells and the routing plan to identify an area of interest (e.g., a heat source) in the digital region, and obtaining a refined placement of the thermal sensing resistor cell such that the thermal sensing resistor cell is over the area of interest. In some embodiments, a thermal sensing resistor according to the present application exhibits no inherent junction voltage and is capable of being placed close to an area of interest (e.g., in the metallization layers right above a heat source) where a temperature is to be measured. Accordingly, the measurement accuracy based on a thermal sensing resistor according to the present application is improved. In some embodiments, a thermal sensing resistor according to the present application is designed based on a designed flow incorporated into the digital design flow and manufactured based on (and integrated with) a back-end-of-line (BEOL) process. Accordingly, the production cost and design overhead for a thermal sensing resistor according to the present application is reduced.

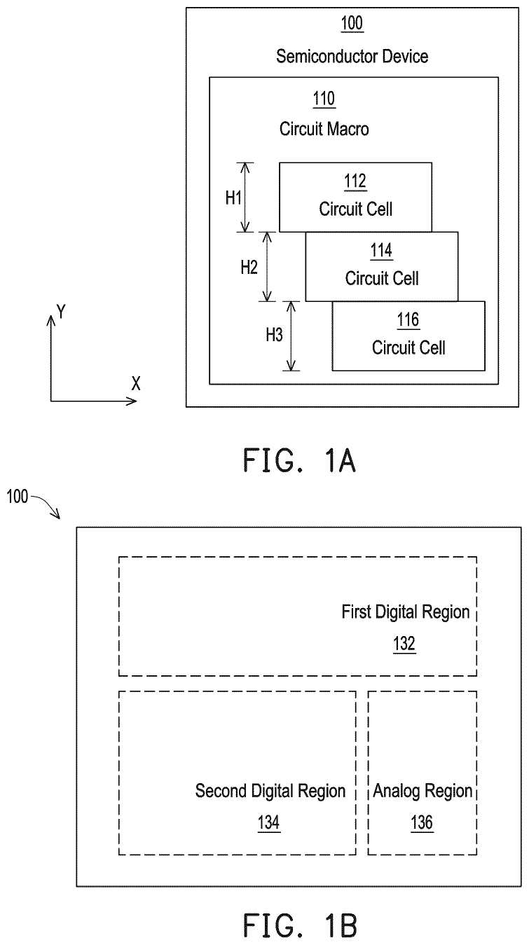

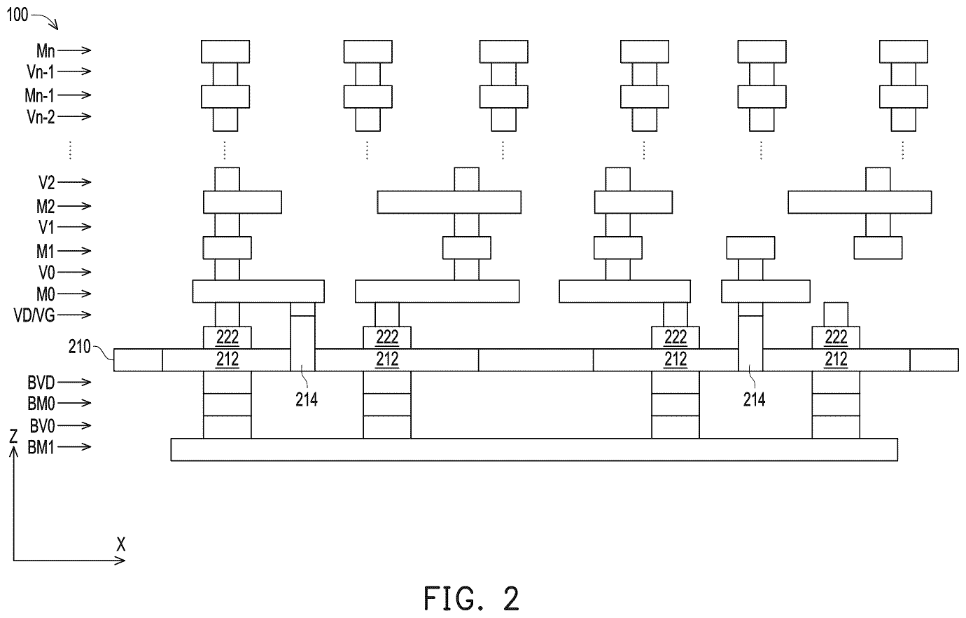

FIG. 1A is a block diagram of a semiconductor device 100, in accordance with some embodiments of the present disclosure. In some embodiments, semiconductor device 100 corresponds to an IC device or a portion of the IC device.

As in FIG. 1A, semiconductor device 100 includes, among other things, at least one circuit macro 110. In some embodiments, circuit macro 110 corresponds to a set of semiconductor components configured as a memory, a controller, one or more logic gates, or the like. Circuit macro 110 includes, among other things, one or more circuit cells, such as circuit cell 112, circuit cell 114, and circuit cell 116. In some embodiments, each one of circuit cells 112, 114, and 116 includes layout patterns indicative of transistors formed based on one or more active regions extending along a first direction (e.g., the X direction) and one or more gate structures extending along a second direction (e.g., the Y direction). In some embodiments, each one of circuit cells 112, 114, and 116 has a corresponding cell height H1, H2, and H3 measurable along the second direction.

In some embodiments, each one of circuit cells 112, 114, and 116 includes layout patterns indicative of respective conductive tracks within one or more metallization layers and electrically connecting various transistors indicated by each one of circuit cells 112, 114, and 116. In some embodiments, the semiconductor device 100 defines multiple power track regions extending along the first direction configured to carry a first supply voltage (e.g., VDD) or a second supply voltage (e.g., VSS or ground). In some embodiments, a circuit cell includes a first side extending along a power track region and a second side extending along another power track region. In some embodiments, a circuit cell that does not have any other power track region between the first side and the second side thereof is sometimes referred to as having a standard cell height. In some embodiments for a more compact design based on some processing nodes, a circuit cell having a standard cell height includes up to four metallization regions (other than the power track regions) extending along the first direction in a lowest metallization layer (also referred to as M0 layer) over the transistors of the circuit cell. In some embodiments, any of cell height H1, H2, and H3 has a standard cell height (e.g., a 1H cell), two standard cell heights (e.g., a 2H cell), three standard cell heights (e.g., a 3H cell). In some embodiments, a cell in circuit macro 110 corresponds to multiple standard cell heights or less than one standard cell height (e.g., a 1/2H cell).

FIG. 1B is a simplified floor plan of a semiconductor device (e.g., semiconductor device 100), in accordance with some embodiments. In the non-limiting embodiment of FIG. 1B, the floor plan of semiconductor device 100 includes a plurality of regions, such as a first digital region 132, a second digital region 134, and an analog region 136. In some embodiments, most of the circuit blocks and components on a substrate and other components disposed in the metallization layers of semiconductor device 100 in first digital region 132 and second digital region 134 are designed based on circuit cells and component cells that are automatically selected and placed by an electronic design automation (EDA) system. In some embodiments, most of the circuit blocks and components in analog region 136 are tailored based on an analog circuit designer adjusting and assigning the placement and dimensions thereof through operating the EDA system. In some embodiments, the circuit blocks and components in first digital region 132 and second digital region 134 are to be made with a higher density, smaller operating voltage, smaller dynamic voltage, and faster operating speed; and the circuit blocks and components in analog region 136 are to be made with a lower density, higher operating voltage, greater dynamic voltage, and slower operating speed.

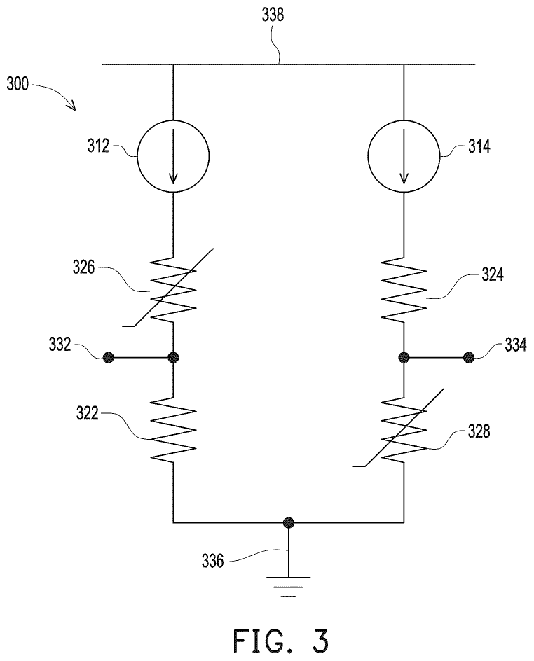

FIG. 2 is a cross-sectional view of a semiconductor device (e.g., semiconductor device 100), in accordance with some embodiments. In some embodiments, the cross-sectional view is a simplified cross-sectional view, with many features simplified or not depicted.

Semiconductor device 100 in FIG. 2 includes a substrate 210 with active regions 212 and gate structures 214 formed at least partially in substrate 210. In this example, semiconductor device 100 includes metal-to-drain/source (MD) structures 222 coupled to the active regions 212. In this example, semiconductor device 100 includes via-to-drain/source (VD) structures connected to MD structures 222 and via-to-gate (VG) structures connected to gate structures 214 at a VD/VG layer above substrate 210 (with respect to a direction Z). In some embodiments, semiconductor device 100 further includes a plurality of metallization layers (e.g., M0, M1, M2, . . . , Mn-1, and Mn layers) and a plurality of via layers (e.g., V0, V1, V2, . . . , Vn-2, and Vn-1 layers) over the VD/VG layer and substrate 210 (n being a positive integer). In some embodiments, a number of metallization layers over substrate 210 ranges from 8 to 14. In some embodiments, Vn-1 layer denotes the via structures between and connecting conductive lines in Mn-1 layer and Mn layer. In some embodiments, M0 layer denotes the first metallization layer above substrate 210. In some embodiments, the plurality of metallization layers and the plurality of via layers includes a conductive material including copper, aluminum, gold, tungsten, a combination thereof, or the like.

Semiconductor device 100 in FIG. 2, as a non-limiting example, further includes conductive structures disposed under substrate 210. For example, semiconductor device 100 further includes backside metallization layers BM0 and BM1 and backside via layers BVD and BV0. In this example, BVD layer denotes backside via structures between and connecting active regions 212 and backside conductive lines in BM0 layer; and BV0 layer denotes backside via structures between and connecting backside conductive lines in BM0 layer and BM1 layer. In some embodiments, BM0 layer denotes the first metallization layer under substrate 210. In this example, there are two backside metallization layers and corresponding via layers. In some embodiments, a number of backside metallization layers under substrate 210 ranges from 2 to 6. In some embodiments, a portion or all of the backside conductive structures (e.g., backside metallization layers BM0 and BM1 and backside via layers BVD and BV0) are at least partially embedded in substrate 210. In some embodiments, backside metallization layers BM0 and BM1 and backside via layers BVD and BV0 includes a conductive material including copper, aluminum, gold, tungsten, a combination thereof, or the like. In some other embodiments, a semiconductor device does not include any backside conductive structures.

In some embodiments, semiconductor device 100 includes one or more redistribution layers and conductive pad structures (not in FIG. 2) over the one or more redistribution layers.

In some embodiments, semiconductor device 100 further includes conductive terminal structures (e.g., conductive bumps, copper pillar bumps, solder bumps, or the like, not in FIG. 2) over the conductive pad structures. In some embodiments, semiconductor device 100 also includes one or more backside redistribution layers and backside conductive pad structures (not in FIG. 2) under the one or more backside redistribution layers. In some embodiments, semiconductor device 100 also includes backside conductive terminal structures (e.g., conductive bumps, copper pillar bumps, solder bumps, or the like, not in FIG. 2) under the backside conductive pad structures.

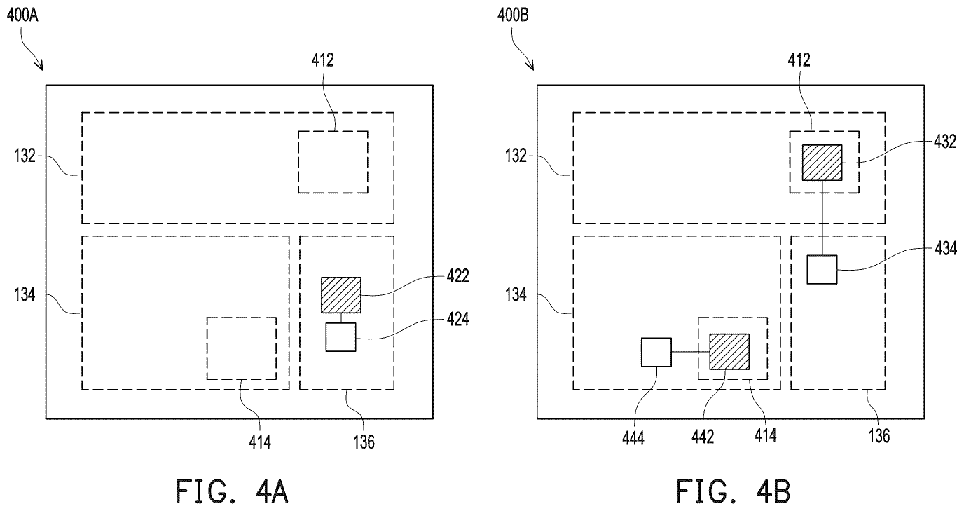

FIG. 3 is a circuit diagram of a temperature sensor 300, in accordance with some embodiments. In some embodiments, the circuit diagram in FIG. 3 is a simplified circuit diagram of temperature sensor 300, which in some embodiments includes other components not fully depicted or omitted in FIG. 3.

Temperature sensor 300 includes two current sources 312 and 314, two resistors 322 and 324, and two thermal sensing resistors 326 and 328. In FIG. 3, thermal sensing resistor 326 includes one terminal electrically coupled to current source 312 and another terminal electrically coupled to resistor 322 at node 332; and resistor 324 includes one terminal electrically coupled to current source 314 and another terminal electrically coupled to thermal sensing resistor 328 at node 334. Also, resistor 322 includes one terminal electrically coupled to node 332 and another terminal electrically coupled to a ground reference node 336; and thermal sensing resistor 328 includes one terminal electrically coupled to node 334 and another terminal electrically coupled to ground reference node 336. In some embodiments, thermal sensing resistors 326 and 328 are configured such that resistance values thereof vary with a temperature at an area of interest (e.g., a heat source in an IC device). In some embodiments, resistors 322 and 324 are configured such that resistance values thereof do not vary with the temperature at the area of interest as much as that of thermal sensing resistors 326 and 328.

In some embodiments, current source 312 is a driving circuit connected to a power supply node 338 and configured to output a driving current to thermal sensing resistor 326 and resistor 322; and current source 314 is another driving circuit connected to the power supply node 338 and configured outputs another driving current to resistor 324 and thermal sensing resistor 328. In some embodiments, a voltage detection circuit (not shown in FIG. 3) is electrically coupled to nodes 332 and 334 and is configured to convert a voltage difference between nodes 332 and 334 to a measured voltage difference in a digital form. In some embodiments, the measured voltage difference also varies with the temperature at the area of interest, and thus represents a measured temperature at the area of interest.

In some embodiments, the voltage detection circuit includes an analog-to-digital converter that is based on a sigma-delta architecture, a dual slope architecture, or a flash architecture. In some embodiments, temperature sensor 300 is formed in a digital region or in an analog region of an IC device. In some embodiments, the corresponding voltage detection circuit is formed in the analog region, in the digital region, or partially in the analog region and partially in the digital region, of the IC device.

Temperature sensor 300 in FIG. 3 is based on a differential-signals architecture. In some embodiments, a temperature sensor is based on a single-ended architecture. For example, based on single-ended architecture, the voltage level at node 332 is used to measure the temperature reflected by thermal sensing resistor 326, and current source 314, resistor 324, and thermal sensing resistor 328 are omitted.

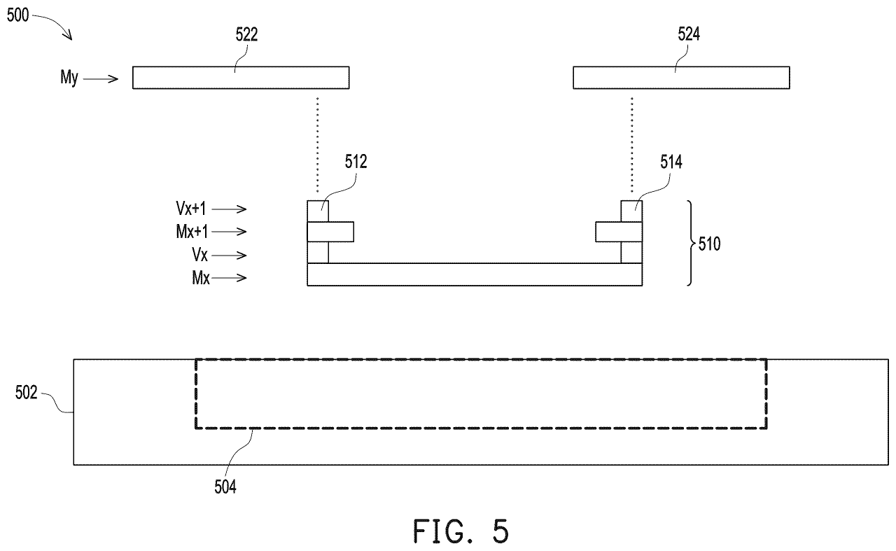

FIG. 4A is a simplified floor plan 400A of a semiconductor device with two areas of interest as a non-limiting example, in accordance with some embodiments. In some embodiments, the semiconductor device corresponds to semiconductor device 100 in FIG. 1B and includes first digital region 132, second digital region 134, and analog region 136. In FIG. 4A, a temperature of an area 412 in the first digital region 132 and a temperature of an area 414 in the second digital region 134 are measured and used for operation of the semiconductor device 100. Therefore, areas 412 and 414 are also referred to in this disclosure as areas of interest. For example, in some embodiments, areas 412 and 414 correspond to processor cores of a central processing unit (CPU) or a graphics processing unit (GPU), which operate based on a high frequency (e.g., greater than 1 Gigahertz, GHz) clock signal and generate a great amount of heat during operation. In some embodiments, in order to prevent damage or errors caused by overheating, the operations of the processor cores are throttled or selectively paused based on the temperature at areas 412 and/or 414.

In some embodiments, to measure the temperature at areas 412 and 414, a thermal sensing resistor (e.g., the thermal sensing resistor 326 or 328 in FIG. 3) is implemented based on a vertical bipolar junction transistor (BJT) at a location 422 in the analog region 136. In some embodiments, considering the junction voltage of the BJT (e.g., about 0.7 volts), the corresponding driving circuit (e.g., the current sources 312 and 314 in FIG. 3) is to be coupled to a power supply node (e.g., the power supply node 328 in FIG. 3) that carries a supply voltage well above 0.7 volts (e.g., 1.2 volts). In addition, considering the location 422 of the BJT is in analog region 136, the corresponding driving circuit is likely to be placed at location 424 in the analog region 136. Accordingly, the design flow for the thermal sensing resistor (i.e., the BJT) at location 422 and the corresponding driving circuit at location 424 would be based on an analog design flow, where most of the components and layouts are tailored by design engineers instead of a cell-based automation process.

FIG. 4B is a simplified floor plan 400B of a semiconductor device with two areas of interest as a non-limiting example, in accordance with some embodiments. In some embodiments, the semiconductor device also corresponds to semiconductor device 100 in FIG. 1B and includes first digital region 132, second digital region 134, and analog region 136. In FIG. 4B, as similarly described above for FIG. 4A, a temperature of area 412 in the first digital region 132 and a temperature of area 414 in the second digital region 134 are measured and used for operation of the semiconductor device 100.

In some embodiments, to measure the temperature at areas 412 and 414, a thermal sensing resistor (e.g., the thermal sensing resistor 326 or 328 in FIG. 3) is implemented based on a resistor formed in a subset of a plurality of metallization layers of a layout plan of the semiconductor device 100. In some embodiments, such thermal sensing resistor is disposed in the digital areas above the areas 412 and 414 (e.g., locations 432 and 442). Compared to location 422 in FIG. 4A for a thermal sensing resistor based on a BJT, a thermal sensing resistor based on the conductive structures of the metallization layers is placed above the circuit blocks being the heat sources in the areas of interest (e.g., areas 412 and 414). Accordingly, the design flow for the thermal sensing resistor implemented in the metallization layers would be based on a digital design flow, where most of the components and layouts are cell-based for automation. In some embodiments, a driving circuit is placed at a location in the analog region (e.g., at location 434 in analog region 136) outside the digital region of the thermal sensing resistor (e.g., at location 432 in first digital region 132), with a supply voltage ranging from 1.0˜1.8 volts. Also, a thermal sensing resistor based on the conductive structures of the metallization layers has no inherent junction voltage that sets up a minimum requirement of the supply voltage of a corresponding driving circuit. As such, in some embodiments, a driving circuit is placed at a location in the same digital region 136 (e.g., at location 444 in second digital region 134) as the digital region of the thermal sensing resistor (e.g., at location 442 in second digital region 134), with a supply voltage ranging from 0.55˜0.75 volts.

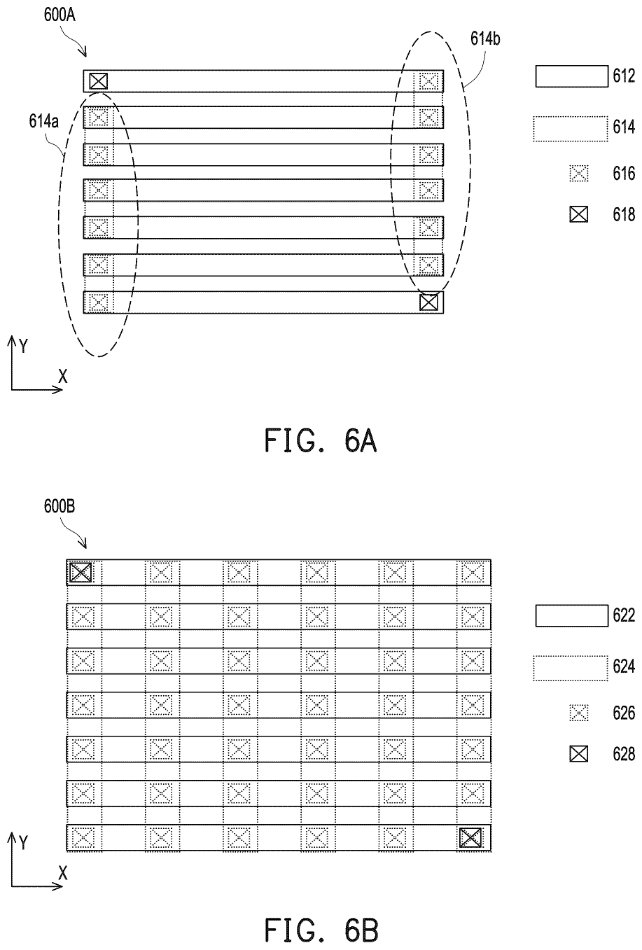

FIG. 5 is a cross-sectional view of a semiconductor device 500 with a thermal sensing resistor 510 formed in the metallization layers, in accordance with some embodiments. In some embodiments, the cross-sectional view is a simplified cross-sectional view, with many features simplified or not depicted.

In FIG. 5, semiconductor device 500 includes a substrate 502 and a digital region 504, which includes digital circuit blocks and is designed based on a digital design flow and a set of design rules applicable to digital circuit blocks. In some embodiments, the digital circuit blocks include one or more of inverters, buffers, NAND gates, NOR gates, memory cells, multiplexer, a combination thereof, or the like.

The thermal sensing resistor 510 is in a subset of a plurality of metallization layers (e.g., metallization layers Mx and Mx+1) and a subset of a plurality of via layers (e.g., via layers Vx and Vx+1) of semiconductor device 500 (x being a positive integer). In some embodiments, the subset of the plurality of metallization layers of the layout plan corresponds to forming conductive lines during a BEOL process. In some embodiments, the subset of the plurality of metallization layers of the layout plan corresponds to one or more of a fourth, a fifth, or a sixth metallization layer (e.g., M3, M4, and/or M5) above the digital circuit blocks formed in the substrate 502. In some embodiments, thermal sensing resistor 510 corresponds to having one or more conductive lines of a width of 20 nanometers (nm) to 36 nm. In some embodiments, two terminals of the thermal sensing resistor 510 have a conductive path of a length ranging from 10 micrometers (μm) to 50 μm. In some embodiments, thermal sensing resistor 510 corresponds to having a resistance value of 10 kiloohms (kΩ) to 50 kΩ.

In the non-limiting example of FIG. 5, thermal sensing resistor 510 is formed based on conductive lines in Mx metallization layer and Mx+1 metallization layer, together with via structures in via layer Vx. In this non-limiting example, thermal sensing resistor 510 further includes two terminals formed based on two via structures 512 and 514 in via layer Vx+1. In some embodiments, x corresponds to 3, 4, or 5.

In some embodiments, semiconductor device 500 further includes one or more conductive lines 522 and 524 in one or more metallization layers above the thermal sensing resistor 510 (e.g., at My metallization layer, y ranges 8-14) for coupling a terminal (e.g., via structure 512 or via structure 514) of thermal sensing resistor 510 to a corresponding driving circuit.

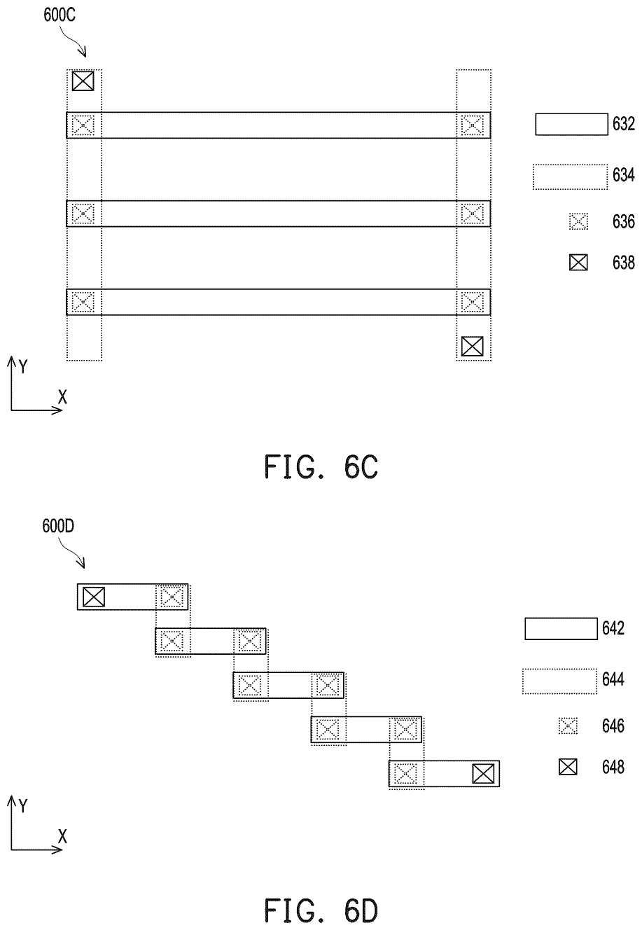

FIG. 6A is a layout diagram of a first thermal sensing resistor cell example 600A, in accordance with some embodiments. In some embodiments, a thermal sensing resistor (e.g., thermal sensing resistor 500 in FIG. 5 or thermal sensing resistor 326 or thermal sensing resistor 328 in FIG. 3) is formed based on layout patterns specified in first thermal sensing resistor cell example 600A.

First thermal sensing resistor cell example 600A in FIG. 6A includes layout patterns indicative of a first plurality of conductive lines (layout patterns 612) along a first direction (e.g., the X direction) in a metallization layer (e.g., the Mx metallization layer in FIG. 5); a second plurality of conductive lines (layout patterns 614) along a second direction (e.g., the Y direction) in another metallization layer (e.g., the Mx+1 metallization layer in FIG. 5); and a plurality of via structures (layout patterns 616) in a via layer (e.g., the Vx via layer in FIG. 5). In FIG. 6A, a first portion of layout patterns 614 is at one end of the cell in an area 614a, and a second portion of layout patterns 614 is at another end of the cell in an area 614b.

In some embodiments, the plurality of via structures (indicated by layout patterns 616) is configured to connect the first plurality of conductive lines (indicated by layout patterns 612) and the second plurality of conductive lines (indicated by layout patterns 614) to form a first conductive strip extending in a back-and-forth manner along the first direction. First thermal sensing resistor cell example 600A in FIG. 6A further includes layout patterns 618 indicative of via structures at two ends of the conductive strip as terminals of the resulting thermal sensing resistor in another via layer (e.g., the Vx+1 via layer in FIG. 5).

FIG. 6B is a layout diagram of a second thermal sensing resistor cell example 600B, in accordance with some embodiments. In some embodiments, a thermal sensing resistor (e.g., thermal sensing resistor 500 in FIG. 5 or thermal sensing resistor 326 or thermal sensing resistor 328 in FIG. 3) is formed based on layout patterns specified in second thermal sensing resistor cell example 600B.

Second thermal sensing resistor cell example 600B in FIG. 6B includes layout patterns indicative of a first plurality of conductive lines (layout patterns 622) along a first direction (e.g., the X direction) in a metallization layer (e.g., the Mx metallization layer in FIG. 5); a second plurality of conductive lines (layout patterns 624) along a second direction (e.g., the Y direction) in another metallization layer (e.g., the Mx+1 metallization layer in FIG. 5); and a plurality of via structures (layout patterns 626) in a via layer (e.g., the Vx via layer in FIG. 5). In FIG. 6B, layout patterns 622 are evenly distributed along the second direction, and layout patterns 624 are evenly distributed along the first direction.

In some embodiments, the plurality of via structures (indicated by layout patterns 626) is configured to connect the first plurality of conductive lines (indicated by layout patterns 622) and the second plurality of conductive lines (indicated by layout patterns 624) to form a conductive grid mesh. Second thermal sensing resistor cell example 600B in FIG. 6B further includes layout patterns 628 indicative of via structures at two corners of the conductive grid mesh as terminals of the resulting thermal sensing resistor in another via layer (e.g., the Vx+1 via layer in FIG. 5).

FIG. 6C is a layout diagram of a third thermal sensing resistor cell example 600C, in accordance with some embodiments. In some embodiments, a thermal sensing resistor (e.g., thermal sensing resistor 500 in FIG. 5 or thermal sensing resistor 326 or thermal sensing resistor 328 in FIG. 3) is formed based on layout patterns specified in third thermal sensing resistor cell example 600C.

Third thermal sensing resistor cell example 600C in FIG. 6C includes layout patterns indicative of a first plurality of conductive lines (layout patterns 632) along a first direction (e.g., the X direction) in a metallization layer (e.g., the Mx metallization layer in FIG. 5); a second plurality of conductive lines (layout patterns 634) along a second direction (e.g., the Y direction) in another metallization layer (e.g., the Mx+1 metallization layer in FIG. 5); and a plurality of via structures (layout patterns 636) in a via layer (e.g., the Vx via layer in FIG. 5). In FIG. 6C, the layout patterns 634 include a layout pattern on the left side (with respect to the first direction) of the cell and another layout pattern on the right side (with respect to the first direction) of the cell; and layout patterns 632 are evenly distributed along the second direction.

In some embodiments, the plurality of via structures (indicated by layout patterns 636) is configured to connect the first plurality of conductive lines (indicated by layout patterns 632) and the second plurality of conductive lines (indicated by layout patterns 634) to form a conductive ladder mesh. Third thermal sensing resistor cell example 600C in FIG. 6C further includes layout patterns 638 indicative of via structures at two corners of the conductive ladder mesh as terminals of the resulting thermal sensing resistor in another via layer (e.g., the Vx+1 via layer in FIG. 5).

FIG. 6D is a layout diagram of a fourth thermal sensing resistor cell example 600D, in accordance with some embodiments. In some embodiments, a thermal sensing resistor (e.g., thermal sensing resistor 500 in FIG. 5 or thermal sensing resistor 326 or thermal sensing resistor 328 in FIG. 3) is formed based on layout patterns specified in fourth thermal sensing resistor cell example 600D.

Fourth thermal sensing resistor cell example 600D in FIG. 6D includes layout patterns indicative of a first plurality of conductive lines (layout patterns 642) along a first direction (e.g., the X direction) in a metallization layer (e.g., the Mx metallization layer in FIG. 5); a second plurality of conductive lines (layout patterns 644) along a second direction (e.g., the Y direction) in another metallization layer (e.g., the Mx+1 metallization layer in FIG. 5); and a plurality of via structures (layout patterns 646) in a via layer (e.g., the Vx via layer in FIG. 5). In FIG. 6D, layout patterns 642 are spread across the first direction and the second direction, and layout patterns 644 are also spread across the first direction and the second direction.

In some embodiments, the plurality of via structures (indicated by layout patterns 646) is configured to connect the first plurality of conductive lines (indicated by layout patterns 642) and the second plurality of conductive lines (indicated by layout patterns 644) to form a second conductive strip extending in a zigzag manner along a diagonal direction different from the first direction and the second direction. Fourth thermal sensing resistor cell example 600D in FIG. 6D further includes layout patterns 648 indicative of via structures at two ends of the conductive strip as terminals of the resulting thermal sensing resistor in another via layer (e.g., the Vx+1 via layer in FIG. 5).

FIG. 6E is a layout diagram of a fifth thermal sensing resistor cell example 600E, in accordance with some embodiments. In some embodiments, a thermal sensing resistor (e.g., thermal sensing resistor 500 in FIG. 5 or thermal sensing resistor 326 or thermal sensing resistor 328 in FIG. 3) is formed based on layout patterns specified in fifth thermal sensing resistor cell example 600E.

Fifth thermal sensing resistor cell example 600E in FIG. 6E includes layout patterns indicative of a first plurality of conductive lines (layout patterns 652) along a first direction (e.g., the X direction) in a metallization layer (e.g., the Mx metallization layer in FIG. 5); a second plurality of conductive lines (layout patterns 654) along a second direction (e.g., the Y direction) in another metallization layer (e.g., the Mx+1 metallization layer in FIG. 5); and a plurality of via structures (layout patterns 656) in a via layer (e.g., the Vx via layer in FIG. 5). In FIG. 6E, the layout patterns 654 include longer layout patterns on two sides (with respect to the first direction) of the cell and shorter layout patterns spread across the first direction and the second direction. Also, the layout patterns 652 include longer layout patterns evenly distributed along the second direction and shorter layout patterns at the corner of the cell.

In some embodiments, the plurality of via structures (indicated by layout patterns 656) is configured to connect the first plurality of conductive lines (indicated by layout patterns 652) and the second plurality of conductive lines (indicated by layout patterns 654) to form a modified ladder mesh with twigs (based on the conductive lines indicated by the shorter ones of layout patterns 656). Fifth thermal sensing resistor cell example 600E in FIG. 6E further includes layout patterns 658 indicative of via structures at two corners of the modified ladder mesh as terminals of the resulting thermal sensing resistor in another via layer (e.g., the Vx+1 via layer in FIG. 5).

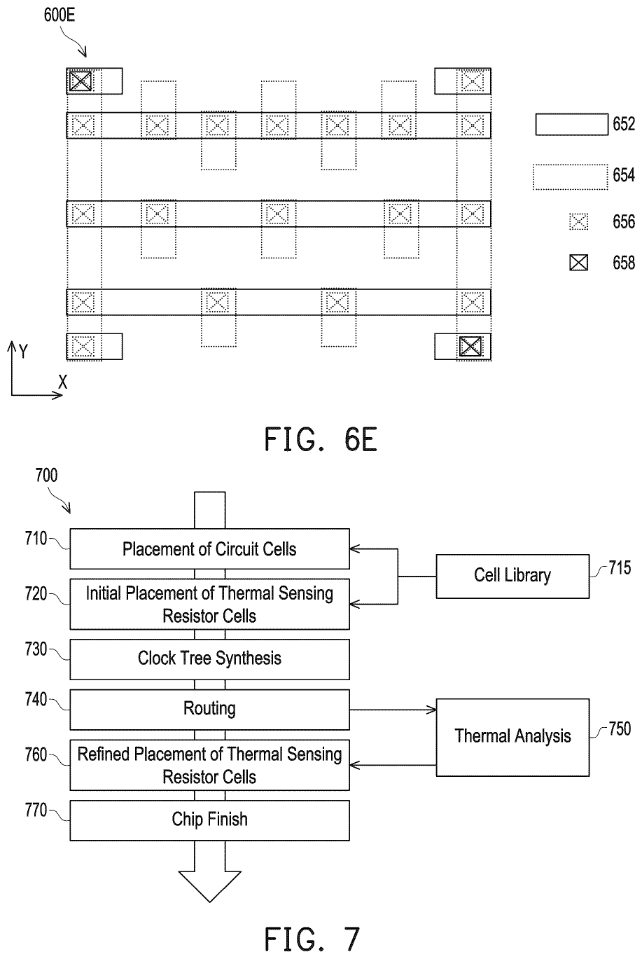

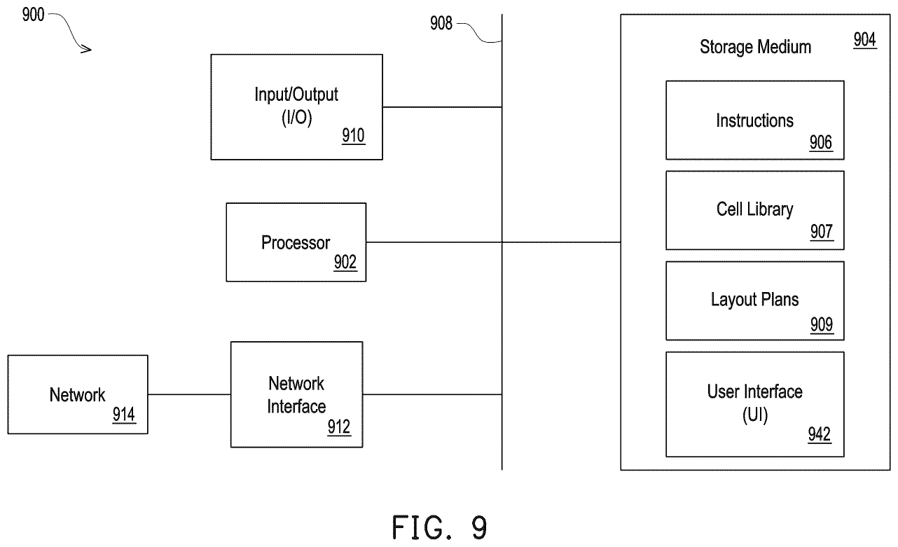

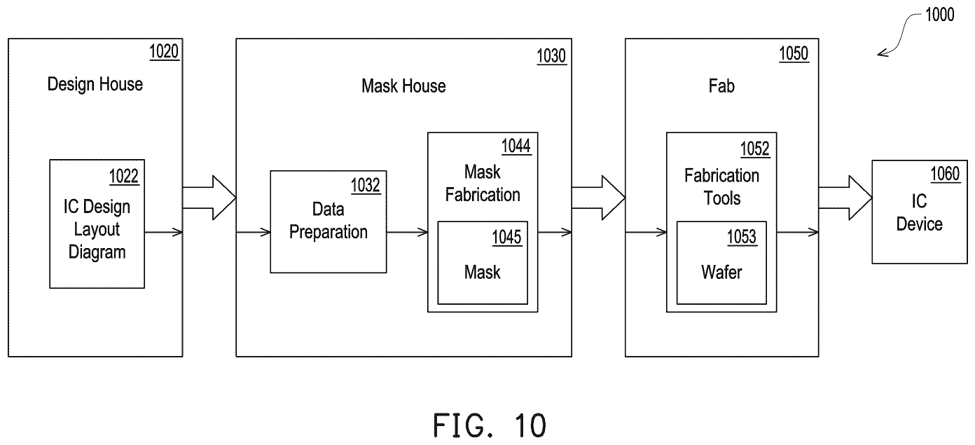

FIG. 7 is a processing flow diagram of at least a portion of an IC design flow 700 for a digital region of a semiconductor device, in accordance with some embodiments. In some embodiments, the design of the thermal sensing resistor described in this disclosure is implemented as part of the IC design flow 700 for a digital region (i.e., a digital design flow). The IC design flow 700 utilizes one or more EDA tools for generating, optimizing, and/or verifying a design of an IC before manufacturing the IC. The EDA tools, in some embodiments, are one or more sets of executable instructions in an EDA system (e.g., an EDA system discussed with respect to FIG. 9) for execution by a processor or controller or a programmed computer to perform the indicated functionality. In at least one embodiment, the IC design flow 700 is performed by a design house of an IC manufacturing system discussed herein with respect to FIG. 10.

At stage 710, based on a design of an IC (e.g., hardware description or functional description of a collection of digital circuit blocks), placement of a plurality of digital circuit cells in a region of a layout plan of the IC is obtained by an EDA system. In some embodiments, the digital circuit cells include cell information indicating sizes, shapes, and positions of various components therein, as well as on or more terminals (i.e., also referred to as “pins” in some applications) of the corresponding cells. In some embodiments, candidate cells are stored in a cell library 715, which is a database recording cell information regarding the candidate cells. In some embodiments, once a circuit cell is selected and placed in the layout plan of the IC device, the subsequent stages of IC design flow 700 interacts with the circuit cells through the terminals of the cells without altering or interfering the components in the cells. In some embodiments, the EDA system obtains the placement of the plurality of digital circuit cells by generating the placement, receiving the placement from another EDA system, or receiving the placement from a memory storing the placement previously generated by the EDA system or the other EDA system.

At stage 720, an initial placement of one or more thermal sensing resistor cells is obtained by the EDA system. In some embodiments, the one or more thermal sensing resistor cells are in a subset of a plurality of metallization layers of the layout plan and a subset of a plurality of via layers of the layout plan over the region of the layout plan. In some embodiments, candidate thermal sensing resistor cells are stored in cell library 715. In some embodiments, the candidate thermal sensing resistor cells are formed based on one or a combination of the examples of FIGS. 6A-6E. In some embodiments, the initial placement may be based on a location of a circuit block that is configured to perform certain functions (e.g., processing cores of a CPU or a GPU). In some embodiments, stage 720 includes, or is integrated into, a dummy keep-out setting stage for initial placement of a heat-dissipation cell (e.g., a chimney pillar structure cell). In some embodiments, the EDA system obtains the placement of the one or more thermal sensing resistor cells by generating the placement, receiving the placement from another EDA system, or receiving the placement from a memory storing the placement previously generated by the EDA system or the other EDA system.

At stage 730, a clock tree synthesis (CTS) is performed by the EDA system to minimize skewing and/or delays potentially present due to the placement of circuit elements in the layout plan. In some embodiments, the CTS includes an optimization process to ensure that the signals are transmitted and/or arrived at appropriate timings. For example, during the CTS, layout patterns indicative of one or more via structures are inserted into the layout plan to add and/or remove slack (timing for signal arrival) to achieve a desired timing.

At stage 740, a routing plan indicative of conductive paths for connecting pins of the plurality of digital circuit cells through the plurality of metallization layers and the plurality of via layers is obtained by the EDA system based on a result of the clock tree synthesis at stage 730 and the initial placement of the one or more thermal sensing resistor cells at stage 720. In some embodiments, the generation of the routing plan is also referred to as a routing process, which is performed to ensure that the routed interconnections or nets satisfy a set of constraints. For example, stage 740 includes global routing process, track assignment, and detailed routing process. During the global routing process, routing resources used for interconnections or nets are allocated. For example, the routing area is divided into a number of sub-areas, pins of the placed circuit elements are mapped to the sub-areas, and nets are constructed as sets of sub-areas in which interconnections are physically routable. During the track assignment, interconnections or nets are assigned by the EDA system to corresponding conductive layers of the layout plan. During the detailed routing process, the EDA system routes interconnections or nets in the assigned conductive layers and within the global routing resources. For example, detailed, physical interconnections are generated within the corresponding sets of sub-areas defined at the global routing and in the conductive layers defined at the track assignment. In some embodiments, the EDA system obtains the routing plan by generating the routing plan, receiving the routing plan from another EDA system, or receiving the routing plan from a memory storing the routing plan previously generated by the EDA system or the other EDA system.

At stage 750, a thermal analysis is performed by the EDA system based on the placement of the plurality of digital circuit cells and the routing plan to identify one or more areas of interest (e.g., heat sources) in the region of the layout plan. In some embodiments, the thermal analysis is based on simulation of operations and power required by the circuit blocks corresponding to the plurality of digital circuit cells and the signal traffic based on the routing plan.

As a result of stage 750, there are cases that the one or more areas of interest where the circuit designer wants to measure the temperature thereof do not exactly correspond to the initial placement of the thermal sensing resistor cells. At stage 760, a refined placement of the one or more thermal sensing resistor cells is obtained by the EDA system, such that the one or more thermal sensing resistor cells are respectively over the one or more areas of interest in the region of the layout plan. In some embodiments, stage 750 includes, or is integrated into, an insertion stage for insertion of a heat-dissipation cell (e.g., a chimney pillar structure cell). In some embodiments, the one or more thermal sensing resistors indicated by the one or more thermal sensing resistor cells also work as heat-dissipation structures. In some embodiments, the EDA system obtains the refined placement of the one or more thermal sensing resistor cells by generating the refined placement, receiving the refined placement from another EDA system, or receiving the refined placement from a memory storing the placement previously generated by the EDA system or the other EDA system.

Stage 770 is referred to as a chip finish stage, where one or more physical and/or timing verifications are performed by the EDA system. For example, stage 770 includes one or more of a resistance and capacitance (RC) extraction, a layout-versus-schematic (LVS) check, a design rule check (DRC), and a timing sign-off check (also referred to as a post-layout simulation). In some embodiments, other verification processes are usable in other embodiments.

In some embodiments, an RC extraction is performed, e.g., by an EDA system, to determine parasitic parameters, e.g., parasitic resistance and parasitic capacitance, of components in the layout plan for timing simulations in a subsequent operation. In some embodiments, an LVS check is performed to ensure that the generated layout plan corresponds to the design of the IC. In some embodiments, a DRC is performed, e.g., by an EDA system, to ensure that the layout plan satisfies certain manufacturing design rules, i.e., to ensure manufacturability of the IC device. In some embodiments, a timing sign-off check (post-layout simulation) is performed, e.g., by an EDA system, to determine, taking the extracted parasitic parameters into account, whether the layout plan meets a predetermined specification of one or more timing requirements.

In some embodiments, at stage 770, if the generated layout plan fails one or more verification operations, the design flow 700 proceeds to an earlier stage, such as stage 710, 730, or 740 for modification based on the result from stage 770. In some embodiments, at stage 770, if the generated layout plan passes all the verification operations, the layout plan is output and stored, in a memory of a processing device, where the layout plan of the IC device includes the placement of the plurality of digital circuit cells, the routing plan, and the refined placement of the one or more thermal sensing resistor cells. In some embodiments, the layout plan is generated and/or stored in the form of a Graphic Design System (GDS) file. Other data formats for describing the design of the IC are within the scope of various embodiments.

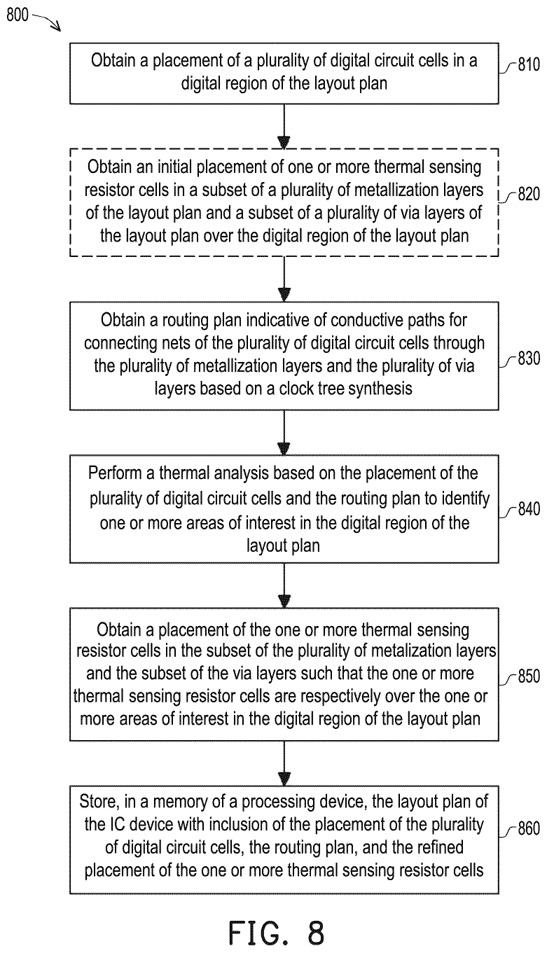

FIG. 8 is a flowchart of a method 800 of forming a layout plan of an IC device, in accordance with some embodiments. In some embodiments, various operations of method 800 are performed by an EDA system as discussed with respect to the EDA system in FIG. 9. In some embodiments, method 800 corresponds to an IC design flow example in FIG. 7. As in FIG. 8, method 800 includes blocks 810-860.

At block 810, a placement of a plurality of digital circuit cells in a region of the layout plan of an IC device is obtained. In some embodiments, the region of the layout plan corresponds to a region that is designed based on a digital design flow and a set of design rules applicable to digital circuit blocks. In some embodiments, the digital circuit cells are for forming the digital circuit blocks that include one or more of inverters, buffers, NAND gates, NOR gates, memory cells, multiplexer, any combination thereof, or the like. In some embodiments, block 810 corresponds to operations at stage 710 in FIG. 7. In some embodiments, an EDA system obtains the placement of the plurality of digital circuit cells by generating the placement, receiving the placement from another EDA system, or receiving the placement from a memory storing the placement previously generated by the EDA system or the other EDA system.

At block 820, an initial placement of one or more thermal sensing resistor cells in a subset of a plurality of metallization layers of the layout plan and a subset of a plurality of via layers of the layout plan is obtained. In some embodiments, the one or more thermal sensing resistor cells are for forming thermal sensing resistors 326 and 328 in FIG. 3, or thermal sensing resistors 510 in FIG. 5. In some embodiments, the one or more thermal sensing resistor cells correspond to the thermal sensing resistor cell examples in FIGS. 6A-6E. In some embodiments, block 820 corresponds to operations at stage 720 in FIG. 7. In some embodiments, an EDA system obtains the placement of the one or more thermal sensing resistor cells by generating the placement, receiving the placement from another EDA system, or receiving the placement from a memory storing the placement previously generated by the EDA system or the other EDA system.

In some embodiments, the subset of the plurality of metallization layers of the layout plan corresponds to forming conductive lines during a BEOL process. In some embodiments, the subset of the plurality of metallization layers of the layout plan corresponds to one or more of a fourth, a fifth, or a sixth metallization layer above the plurality of circuit cells. In some embodiments, at least one of the one or more thermal sensing resistor cells corresponds to forming one or more conductive lines of a width of 20 nm to 36 nm. In some embodiments, at least one of the one or more thermal sensing resistor cells corresponds to forming a resistor having a resistance value of 10 kΩ to 50 kΩ.

In some embodiments, at least one of the one or more thermal sensing resistor cells corresponds to forming a first plurality of conductive lines along a first direction in a metallization layer, a second plurality of conductive lines along a second direction in another metallization layer, and a plurality of via structures. In some embodiments, the plurality of via structures connects the first plurality of conductive lines and the second plurality of conductive lines to form a first conductive strip extending in a back-and-forth manner along the first direction (e.g., based on first thermal sensing resistor cell example 600A), a conductive grid mesh (e.g., based on second thermal sensing resistor cell example 600B), a conductive ladder mesh (e.g., based on third thermal sensing resistor cell example 600C), a second conductive strip extending in a zigzag manner along a diagonal direction different from the first direction and the second direction (e.g., based on fourth thermal sensing resistor cell example 600D), or a modified ladder mesh with twigs (e.g., based on fifth thermal sensing resistor cell example 600E).

At block 830, a routing plan indicative of conductive paths for connecting pins of the plurality of digital circuit cells through the plurality of metallization layers and the plurality of via layers is obtained based on a clock tree synthesis and the initial placement of the one or more thermal sensing resistor cells. In some embodiments, block 830 corresponds to operations at stage 730 and 740 in FIG. 7. In some embodiments, an EDA system obtains the routing plan by generating the routing plan, receiving the routing plan from another EDA system, or receiving the routing plan from a memory storing the routing plan previously generated by the EDA system or the other EDA system.

At block 840, a thermal analysis is performed based on the placement of the plurality of digital circuit cells and the routing plan to identify one or more areas of interest in the region of the layout plan. In some embodiments, block 840 corresponds to operations at stage 750 in FIG. 7.

At block 850, a refined placement of the one or more thermal sensing resistor cells is obtained such that the one or more thermal sensing resistor cells are respectively over the one or more areas of interest in the region of the layout plan. In some embodiments, the refined placement corresponds to locations 432 and 442 in FIG. 4B. In some embodiments, block 850 corresponds to the operations at stage 760 in FIG. 7. In some embodiments, an EDA system obtains the refined placement of the one or more thermal sensing resistor cells by generating the refined placement, receiving the refined placement from another EDA system, or receiving the refined placement from a memory storing the refined placement previously generated by the EDA system or the other EDA system.

At block 860, the layout plan of the IC device, with inclusion of the placement of the plurality of digital circuit cells, the routing plan, and the refined placement of the one or more thermal sensing resistor cells, is stored in a memory of a processing device. In some embodiments, block 860 corresponds to the operations at stage 770 in FIG. 7.

In some embodiments, method 800 further includes obtaining a placement of a driving circuit block in the region of the layout plan. In some embodiments, the driving circuit block and one of the one or more thermal sensing resistor cells correspond to formation of a part of a temperature sensor block. In some embodiments, the routing plan includes a conductive path for coupling a terminal of the one of the one or more thermal sensing resistor cells to the driving circuit block. In some embodiments, the conductive path is in one or more metallization layers above the one of the one or more thermal sensing resistor cells. In some embodiments, an EDA system obtains the placement of a driving circuit block by generating the placement, receiving the placement from another EDA system, or receiving the placement from a memory storing the placement previously generated by the EDA system or the other EDA system.

FIG. 9 is a block diagram of an electronic design automation (EDA) system 900 in accordance with some embodiments. In some embodiments, EDA system 900 includes an automatic placement and routing (APR) system. Methods described herein of designing layout diagrams represent wire routing arrangements, in accordance with one or more embodiments, are implementable, for example, using EDA system 900, in accordance with some embodiments.

In some embodiments, EDA system 900 is a general-purpose computing device including a hardware processor 902 and a computer-readable storage medium 904. Storage medium 904, amongst other things, is encoded with, i.e., stores, computer program code 906, i.e., a set of executable instructions. Execution of instructions 906 by hardware processor 902 represents (at least in part) an EDA tool which implements a portion or all of the methods described herein in accordance with one or more embodiments (hereinafter, the noted processes and/or methods).

Processor 902 is electrically coupled to computer-readable storage medium 904 via a bus 908. Processor 902 is also electrically coupled to an I/O interface 910 by bus 908. A network interface 912 is also electrically connected to processor 902 via bus 908. Network interface 912 is connected to a network 914, so that processor 902 and computer-readable storage medium 904 are capable of connecting to external elements via network 914. Processor 902 is configured to execute computer program code 906 encoded in computer-readable storage medium 904 in order to cause system 900 to be usable for performing a portion or all of the noted processes and/or methods. In one or more embodiments, processor 902 is a CPU, a multi-processor, a distributed processing system, an application specific integrated circuit (ASIC), and/or a suitable processing unit.

In one or more embodiments, computer-readable storage medium 904 is a non-transitory computer-readable storage medium including an electronic, magnetic, optical, electromagnetic, infrared, and/or a semiconductor system (or apparatus or device). For example, computer-readable storage medium 904 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 904 includes a compact disk-read only memory (CD-ROM), a compact disk-read/write (CD-R/W), and/or a digital video disc (DVD).

In one or more embodiments, storage medium 904 stores computer program code 906 configured to cause system 900 (where such execution represents (at least in part) the EDA tool) to be usable for performing a portion or all of the noted processes and/or methods. In one or more embodiments, storage medium 904 also stores information which facilitates performing a portion or all of the noted processes and/or methods. In one or more embodiments, storage medium 904 stores a cell library 907 of standard cells including such standard cells as disclosed herein. In one or more embodiments, storage medium 904 stores one or more layout plans 909 corresponding to one or more layouts plans disclosed herein.

EDA system 900 includes I/O interface 910. I/O interface 910 is coupled to external circuitry. In one or more embodiments, I/O interface 910 includes a keyboard, keypad, mouse, trackball, trackpad, touchscreen, and/or cursor direction keys for communicating information and commands to processor 902.

EDA system 900 also includes network interface 912 coupled to processor 902. Network interface 912 allows system 900 to communicate with network 914, to which one or more other computer systems are connected. Network interface 912 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 900.

System 900 is configured to receive information through I/O interface 910. The information received through I/O interface 910 includes one or more of instructions, data, design rules, libraries of standard cells, and/or other parameters for processing by processor 902. The information is transferred to processor 902 via bus 908. EDA system 900 is configured to receive information related to a UI through I/O interface 910. The information is stored in computer-readable medium 904 as user interface (UI) 942.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 900. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 10 is a block diagram of an IC manufacturing system 1000, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1000.

In FIG. 10, IC manufacturing system 1000 includes entities, such as a design house 1020, a mask house 1030, and an IC manufacturer/fabricator (fab) 1050, that interact with one another in the design, development, and manufacturing cycles and/or services related to manufacturing an IC device 1060. The entities in system 1000 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1020, mask house 1030, and IC fab 1050 is owned by a single larger company. In some embodiments, two or more of design house 1020, mask house 1030, and IC fab 1050 coexist in a common facility and use common resources.

Design house (or design team) 1020 generates an IC design layout diagram 1022 (e.g., a layout plan). IC design layout diagram 1022 includes various geometrical patterns designed for an IC device 1060. The geometrical patterns correspond to patterns of metal, oxide, or semiconductor layers that make up the various components of IC device 1060 to be fabricated. The various layers combine to form various IC features. For example, a portion of IC design layout diagram 1022 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1020 implements a proper design procedure to form IC design layout diagram 1022. The design procedure includes one or more of logic design, physical design or place and route. IC design layout diagram 1022 is presented in one or more data files having information of the geometrical patterns. For example, IC design layout diagram 1022 can be expressed in a GDSII file format or DFII file format.

Mask house 1030 includes data preparation 1032 and mask fabrication 1044. Mask house 1030 uses IC design layout diagram 1022 to manufacture one or more masks 1045 to be used for fabricating the various layers of IC device 1060 according to IC design layout diagram 1022. Mask house 1030 performs mask data preparation 1032, where IC design layout diagram 1022 is translated into a representative data file (RDF). Mask data preparation 1032 provides the RDF to mask fabrication 1044. Mask fabrication 1044 includes a mask writer. A mask writer converts the RDF to an image on a substrate, such as a mask (reticle) 1045 or a semiconductor wafer 1053. The design layout diagram 1022 is manipulated by mask data preparation 1032 to comply with particular characteristics of the mask writer and/or requirements of IC fab 1050. In FIG. 10, mask data preparation 1032 and mask fabrication 1044 are illustrated as separate elements. In some embodiments, mask data preparation 1032 and mask fabrication 1044 can be collectively referred to as mask data preparation.

In some embodiments, mask data preparation 1032 includes optical proximity correction (OPC) which uses lithography enhancement techniques to compensate for image errors, such as those that can arise from diffraction, interference, other process effects and the like. OPC adjusts IC design layout diagram 1022. In some embodiments, mask data preparation 1032 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1032 includes a mask rule checker (MRC) that checks the IC design layout diagram 1022 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1022 to compensate for photolithographic implementation effects during mask fabrication 1044, which may undo part of the modifications performed by OPC in order to meet mask creation rules.

In some embodiments, mask data preparation 1032 includes lithography process checking (LPC) that simulates processing that will be implemented by IC fab 1050 to fabricate IC device 1060. LPC simulates this processing based on IC design layout diagram 1022 to create a simulated manufactured device, such as IC device 1060. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1022.

It should be understood that the above description of mask data preparation 1032 has been simplified for the purposes of clarity. In some embodiments, data preparation 1032 includes additional features such as a logic operation (LOP) to modify the IC design layout diagram 1022 according to manufacturing rules. Additionally, the processes applied to IC design layout diagram 1022 during data preparation 1032 may be executed in a variety of different orders.

After mask data preparation 1032 and during mask fabrication 1044, a mask 1045 or a group of masks 1045 are fabricated based on the modified IC design layout diagram 1022. In some embodiments, mask fabrication 1044 includes performing one or more lithographic exposures based on IC design layout diagram 1022. In some embodiments, an electron-beam (e-beam) or a mechanism of multiple e-beams is used to form a pattern on a mask (photomask or reticle) 1045 based on the modified IC design layout diagram 1022. Mask 1045 can be formed in various technologies. In some embodiments, mask 1045 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1045 includes a transparent substrate (e.g., fused quartz) and an opaque material (e.g., chromium) coated in the opaque regions of the binary mask. In another example, mask 1045 is formed using a phase shift technology. In a phase shift mask (PSM) version of mask 1045, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1044 is used in a variety of processes. For example, such a mask(s) is used in an ion implantation process to form various doped regions in semiconductor wafer 1053, in an etching process to form various etching regions in semiconductor wafer 1053, and/or in other suitable processes.

IC fab 1050 is an IC fabrication business that includes one or more manufacturing facilities for the fabrication of a variety of different IC products. In some embodiments, IC Fab 1050 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1050 includes fabrication tools 1052 configured to execute various manufacturing operations on semiconductor wafer 1053 such that IC device 1060 is fabricated in accordance with the mask(s), e.g., mask 1045. In various embodiments, fabrication tools 1052 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1050 uses mask(s) 1045 fabricated by mask house 1030 to fabricate IC device 1060. Thus, IC fab 1050 at least indirectly uses IC design layout diagram 1022 to fabricate IC device 1060. In some embodiments, semiconductor wafer 1053 is fabricated by IC fab 1050 using mask(s) 1045 to form IC device 1060. In some embodiments, the IC fabrication includes performing one or more lithographic exposures based at least indirectly on IC design layout diagram 1022. Semiconductor wafer 1053 includes a silicon substrate or other proper substrate having material layers formed thereon. Semiconductor wafer 1053 further includes one or more of various doped regions, dielectric features, multilevel interconnects, and the like (formed at subsequent manufacturing steps).

In one aspect, a method of forming a layout plan of an IC device includes obtaining a placement of a plurality of digital circuit cells in a region of the layout plan, obtaining an initial placement of one or more thermal sensing resistor cells in a subset of a plurality of metallization layers of the layout plan and a subset of a plurality of via layers of the layout plan over the region of the layout plan, and obtaining a routing plan indicative of conductive paths for connecting pins of the plurality of digital circuit cells through the plurality of metallization layers and the plurality of via layers based on a clock tree synthesis and the initial placement of the one or more thermal sensing resistor cells. The method further includes performing a thermal analysis based on the placement of the plurality of digital circuit cells and the routing plan to identify one or more areas of interest in the region of the layout plan, and obtaining a refined placement of the one or more thermal sensing resistor cells such that the one or more thermal sensing resistor cells are respectively over the one or more areas of interest in the region of the layout plan. The method further includes storing, in a memory of a processing device, the layout plan of the IC device with inclusion of the placement of the plurality of digital circuit cells, the routing plan, and the refined placement of the one or more thermal sensing resistor cells.

In an aspect, a processing device for forming a layout plan of an IC device includes a memory and processing circuitry coupled to the memory and configured to obtain a placement of a plurality of digital circuit cells in a region of the layout plan, obtain an initial placement of one or more thermal sensing resistor cells in a subset of a plurality of metallization layers of the layout plan and a subset of a plurality of via layers of the layout plan over the region of the layout plan, and obtain a routing plan indicative of conductive paths for connecting pins of the plurality of digital circuit cells through the plurality of metallization layers and the plurality of via layers based on a clock tree synthesis and the initial placement of the one or more thermal sensing resistor cells. The processing circuitry is further configured to perform a thermal analysis based on the placement of the plurality of digital circuit cells and the routing plan to identify one or more areas of interest in the region of the layout plan, and obtain a refined placement of the one or more thermal sensing resistor cells such that the one or more thermal sensing resistor cells are respectively over the one or more areas of interest in the region of the layout plan. The processing circuitry is further configured to store, in the memory, the layout plan of the IC device with inclusion of the placement of the plurality of digital circuit cells, the routing plan, and the refined placement of the one or more thermal sensing resistor cells.

In one aspect, a non-transitory computer-readable medium that stores instructions which, when executed by processing circuitry of a processing device, cause the processing device to obtain a placement of a plurality of digital circuit cells in a region of a layout plan of an IC device, obtain an initial placement of one or more thermal sensing resistor cells in a subset of a plurality of metallization layers of the layout plan and a subset of a plurality of via layers of the layout plan over the region of the layout plan, and obtain a routing plan indicative of conductive paths for connecting pins of the plurality of digital circuit cells through the plurality of metallization layers and the plurality of via layers based on a clock tree synthesis and the initial placement of the one or more thermal sensing resistor cells. The instructions, when executed by the processing circuitry of the processing device, further cause the processing device to perform a thermal analysis based on the placement of the plurality of digital circuit cells and the routing plan to identify one or more areas of interest in the region of the layout plan, and obtain a refined placement of the one or more thermal sensing resistor cells such that the one or more thermal sensing resistor cells are respectively over the one or more areas of interest in the region of the layout plan. The instructions, when executed by the processing circuitry of the processing device, further cause the processing device to store, in a memory of the processing device, the layout plan of the IC device with inclusion of the placement of the plurality of digital circuit cells, the routing plan, and the refined placement of the one or more thermal sensing resistor cells.

In one aspect, an IC device includes a plurality of digital circuit blocks in a region of the IC device and a temperature sensor. The temperature sensor includes a driving circuit in the region of the IC device, one or more thermal sensing resistors in a subset of a plurality of metallization layers of the IC device and a subset of a plurality of via layers of the IC device over the region of the IC device, and a conductive line for coupling a terminal of one of the one or more thermal sensing resistors to the temperature sensor. The the conductive line is in one or more metallization layers above the one of the one or more thermal sensing resistors.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. A method of forming a layout plan of an integrated circuit (IC) device, comprising:
obtaining a placement of a plurality of digital circuit cells in a region of the layout plan;
obtaining an initial placement of one or more thermal sensing resistor cells in a subset of a plurality of metallization layers of the layout plan and a subset of a plurality of via layers of the layout plan over the region of the layout plan;
obtaining a routing plan indicative of conductive paths for connecting pins of the plurality of digital circuit cells through the plurality of metallization layers and the plurality of via layers based on a clock tree synthesis and the initial placement of the one or more thermal sensing resistor cells;
performing a thermal analysis based on the placement of the plurality of digital circuit cells and the routing plan to identify one or more areas of interest in the region of the layout plan;
obtaining a refined placement of the one or more thermal sensing resistor cells such that the one or more thermal sensing resistor cells are respectively over the one or more areas of interest in the region of the layout plan; and
storing, in a memory of a processing device, the layout plan of the IC device with inclusion of the placement of the plurality of digital circuit cells, the routing plan, and the refined placement of the one or more thermal sensing resistor cells.

2. The method of claim 1, wherein
the subset of the plurality of metallization layers of the layout plan corresponds to forming conductive lines during a back-end-of-line (BEOL) process.

3. The method of claim 1, wherein
the subset of the plurality of metallization layers of the layout plan corresponds to one or more of a fourth, a fifth, or a sixth metallization layer above the plurality of circuit cells.

4. The method of claim 1, wherein
at least one of the one or more thermal sensing resistor cells corresponds to forming one or more conductive lines of a width of 20 nanometers (nm) to 36 nm.

5. The method of claim 1, wherein
at least one of the one or more thermal sensing resistor cells corresponds to forming a resistor having a resistance value of 10 kiloohms (kΩ) to 50 kΩ.

6. The method of claim 1, wherein at least one of the one or more thermal sensing resistor cells corresponds to forming:
a first plurality of conductive lines along a first direction in a metallization layer;
a second plurality of conductive lines along a second direction in another metallization layer; and
a plurality of via structures connecting the first plurality of conductive lines and the second plurality of conductive lines to form
a first conductive strip extending in a back-and-forth manner along the first direction,
a conductive grid mesh,
a conductive ladder mesh,
a second conductive strip extending in a zigzag manner along a diagonal direction different from the first direction and the second direction, or
a modified ladder mesh with twigs.

7. The method of claim 1, further comprising:
obtaining a placement of a driving circuit block in the region of the layout plan,
wherein
the driving circuit block and one of the one or more thermal sensing resistor cells correspond to formation of a part of a temperature sensor block,
the routing plan includes a conductive path for coupling a terminal of the one of the one or more thermal sensing resistor cells to the driving circuit block, and
the conductive path is in one or more metallization layers above the one of the one or more thermal sensing resistor cells.

8. A processing device for forming a layout plan of an integrated circuit (IC) device, comprising:
a memory; and
processing circuitry coupled to the memory and configured to:
obtain a placement of a plurality of digital circuit cells in a region of the layout plan;
obtain an initial placement of one or more thermal sensing resistor cells in a subset of a plurality of metallization layers of the layout plan and a subset of a plurality of via layers of the layout plan over the region of the layout plan;
obtain a routing plan indicative of conductive paths for connecting pins of the plurality of digital circuit cells through the plurality of metallization layers and the plurality of via layers based on a clock tree synthesis and the initial placement of the one or more thermal sensing resistor cells;
perform a thermal analysis based on the placement of the plurality of digital circuit cells and the routing plan to identify one or more areas of interest in the region of the layout plan;
obtain a refined placement of the one or more thermal sensing resistor cells such that the one or more thermal sensing resistor cells are respectively over the one or more areas of interest in the region of the layout plan; and
store, in the memory, the layout plan of the IC device with inclusion of the placement of the plurality of digital circuit cells, the routing plan, and the refined placement of the one or more thermal sensing resistor cells.

9. The processing device of claim 8, wherein
the processing circuitry is configured to obtain cell information indicating that the subset of the plurality of metallization layers of the layout plan corresponds to forming conductive lines during a back-end-of-line (BEOL) process.

10. The processing device of claim 8, wherein
the processing circuitry is configured to obtain cell information indicating that the subset of the plurality of metallization layers of the layout plan corresponds to one or more of a fourth, a fifth, or a sixth metallization layer above the plurality of digital circuit cells.

11. The processing device of claim 8, wherein
the processing circuitry is configured to obtain cell information indicating that at least one of the one or more thermal sensing resistor cells corresponds to forming one or more conductive lines of a width of 20 nanometers (nm) to 36 nm.

12. The processing device of claim 8, wherein
the processing circuitry is configured to obtain cell information indicating that at least one of the one or more thermal sensing resistor cells corresponds to forming a resistor having a resistance value of 10 kiloohms (kΩ) to 50 kΩ.

13. The processing device of claim 8, wherein the processing circuitry is configured to obtain cell information indicating that at least one of the one or more thermal sensing resistor cells corresponds to forming:
a first plurality of conductive lines along a first direction in a metallization layer;
a second plurality of conductive lines along a second direction in another metallization layer; and
a plurality of via structures connecting the first plurality of conductive lines and the second plurality of conductive lines to form
a first conductive strip extending in a back-and-forth manner along the first direction,
a conductive grid mesh,
a conductive ladder mesh,
a second conductive strip extending in a zigzag manner along a diagonal direction different from the first direction and the second direction, or
a modified ladder mesh with twigs.

14. The processing device of claim 8, wherein the processing circuitry is further configured to:
obtain a placement of a driving circuit block in the region of the layout plan; and
obtain the routing plan that includes a conductive path for coupling a terminal of one of the one or more thermal sensing resistor cells to the driving circuit block,
wherein
the driving circuit block and the one of the one or more thermal sensing resistor cells correspond to formation of a part of a temperature sensor block, and
the conductive path is in one or more metallization layers above the one of the one or more thermal sensing resistor cells.

15. A non-transitory computer-readable medium that stores instructions which, when executed by processing circuitry of a processing device, cause the processing device to:
obtain a placement of a plurality of digital circuit cells in a region of a layout plan of an integrated circuit (IC) device;
obtain an initial placement of one or more thermal sensing resistor cells in a subset of a plurality of metallization layers of the layout plan and a subset of a plurality of via layers of the layout plan over the region of the layout plan;
obtain a routing plan indicative of conductive paths for connecting pins of the plurality of digital circuit cells through the plurality of metallization layers and the plurality of via layers based on a clock tree synthesis and the initial placement of the one or more thermal sensing resistor cells;
perform a thermal analysis based on the placement of the plurality of digital circuit cells and the routing plan to identify one or more areas of interest in the region of the layout plan;
obtain a refined placement of the one or more thermal sensing resistor cells such that the one or more thermal sensing resistor cells are respectively over the one or more areas of interest in the region of the layout plan; and
store, in a memory of the processing device, the layout plan of the IC device with inclusion of the placement of the plurality of digital circuit cells, the routing plan, and the refined placement of the one or more thermal sensing resistor cells.

16. The non-transitory computer-readable medium of claim 15, wherein
the instructions, when executed by the processing circuitry of the processing device, further cause the processing device to obtain cell information indicating that the subset of the plurality of metallization layers of the layout plan corresponds to forming conductive lines during a back-end-of-line (BEOL) process, and that the subset of the plurality of metallization layers of the layout plan corresponds to one or more of a fourth, a fifth, or a sixth metallization layer above the plurality of digital circuit cells.

17. The non-transitory computer-readable medium of claim 15, wherein
the instructions, when executed by the processing circuitry of the processing device, further cause the processing device to obtain cell information indicating that at least one of the one or more thermal sensing resistor cells corresponds to forming one or more conductive lines of a width of 20 nanometers (nm) to 36 nm.

18. The non-transitory computer-readable medium of claim 15, wherein
the instructions, when executed by the processing circuitry of the processing device, further cause the processing device to obtain cell information indicating that at least one of the one or more thermal sensing resistor cells corresponds to forming a resistor having a resistance value of 10 kiloohms (kΩ) to 50 kΩ.

19. The non-transitory computer-readable medium of claim 15, wherein the instructions, when executed by the processing circuitry of the processing device, further cause the processing device to obtain cell information indicating that at least one of the one or more thermal sensing resistor cells corresponds to forming:
a first plurality of conductive lines along a first direction in a metallization layer;
a second plurality of conductive lines along a second direction in another metallization layer; and
a plurality of via structures connecting the first plurality of conductive lines and the second plurality of conductive lines to form
a first conductive strip extending in a back-and-forth manner along the first direction,
a conductive grid mesh,
a conductive ladder mesh,
a second conductive strip extending in a zigzag manner along a diagonal direction different from the first direction and the second direction, or
a modified ladder mesh with twigs.

20. The non-transitory computer-readable medium of claim 15, wherein the instructions, when executed by the processing circuitry of the processing device, further cause the processing device to:
obtain a placement of a driving circuit block in the region of the layout plan; and
obtain the routing plan that includes a conductive path for coupling a terminal of one of the one or more thermal sensing resistor cells to the driving circuit block,
wherein
the driving circuit block and the one of the one or more thermal sensing resistor cells correspond to formation of a part of a temperature sensor block, and
the conductive path is in one or more metallization layers above the one of the one or more thermal sensing resistor cells.
